(19) United States
(12) Patent Application Publication
(10) Pub. No.: US 2017/0361330 A1
(43) Pub. Date: Dec. 21, 2017

(54) Mobile Size Reduction Device

(71) Applicants: John Forrest Smith, Fort Payne, AL (US); Rebecca Palmer, Fort Payne, AL (US)

(72) Inventors: John Forrest Smith, Fort Payne, AL (US); Rebecca Palmer, Fort Payne, AL (US)

(21) Appl. No.: 15/621,675

(22) Filed: Jun. 13, 2017

Related U.S. Application Data
(60) Provisional application No. 62/350,422, filed on Jun. 15, 2016.

(51) Int. Cl. B02C 21/02; B02C 23/02; B65F 3/14

(52) U.S. Cl. CPC B02C 21/026; B65F 3/14; B02C 23/02; B02C 2201/06

(57) ABSTRACT

A vehicle can be equipped with a size reduction device whereby input is directed, such as with a loading system, up and into an inlet of the size reduction device or a storage body to await loading into the size reduction device, such as with a transfer system. The input is reduced in size to be particulate and then either discharged from an outlet or into a storage body for later removal, possibly with a transfer system.

### CLAIM OF PRIORITY

This application claims the benefit of U.S. Provisional Application No. 62/350,422 filed Jun. 15, 2016 which is incorporate herein by reference in its entirety.

### FIELD OF THE INVENTION

The present invention relates to a size reduction device, such as a pulverizer, also known as a grinding mill, which can be provided along an vertical axis with a rotating shaft and a plurality of arms spinning thereabout which generate a series of air currents inside a cylinder to pulverize, aerate, homogenize and/or separate material, and more particularly to a mobile unit which can be utilized for various purposes having an ability to reduce inserted material in size, whether using a pulverizer or other technology.

### BACKGROUND OF THE INVENTION

Solid material such as garbage or other solid material has been collected in trucks and transported for disposal for many years.

Burkett developed a centrifugal mill sometime around the mid-1970's ending up with U.S. Pat. No. 3,897,970 and others. Others have commercialized an embodiment of the Burkett mill and are marketing those designs in the marketplace today. All of these systems known by the applicant are fixed plant operations designed to be utilized on location. They are relatively substantial fixed place structures.

In examining this technology, the applicant thought that it may be a possibility to improve over the prior art designs to accomplish objectives not met by the prior art.

### SUMMARY OF THE INVENTION

It is a present object of many embodiments of the present invention to provide an improved size reduction device, mill or pulverizer having advanced capabilities.

It is another object of many embodiments of the present invention to provide an improved size reduction device, such as a pulverizer connected to and supported by a frame of a vehicle for use in refuse collection and compacting, and/or other purposes.

It is another object of many embodiments of the present invention to provide an improved angled or even horizontally disposed pulverizer for many embodiments.

It is another object of many embodiments of the present invention to provide an improved vehicle for use in collecting material to then reduce the size of the material as it is received or removed from the vehicle, possibly using pulverizer or other size reduction technology.

Yet another embodiment of the invention provides a size reduction device in front of a cab of a vehicle, and then after collection and reducing the size, directing the reduced size components rearwardly of the cab for temporary storage on the vehicle.

Accordingly, in accordance with a presently preferred embodiment of the present invention, a number of size reduction device configurations are contemplated. First, a size reduction device, such as a pulverizer is anticipated to be located behind a cab of a vehicle for use in pulverizing material for some embodiments as material is provided to the vehicle and then preferably conveyed such as with a transfer system rearwardly relative to the cab to a storage body for use in storing until the vehicle can dump its contents. It is anticipated that the conveyor can lift processed material up and away from a bottom of the size reduction device to an elevated portion of the storage body. It is also possible to have a diverter within the storage body to assist in diverting material to assist in spreading material into the storage body once material has been reduced in size.

Another embodiment envisions reduction in size, possibly using a size reduction device, possibly a pulverizer, possibly as an angled or horizontally disposed size reduction device or pulverizer, to direct material rearwardly into the storage body, possibly coupled with a curved rear door to assist in directing material upwardly as it is directed into the storage body.

Still some other embodiments envision utilizing a horizontally disposed size reduction device or mill which is not believed to ever been done before. While the through put may be slower with a horizontally disposed mill, and certainly gravity would have tendency to pull things down against a side of the drum (instead of through for a vertical mill), depending upon the speed of operation, angle of inclination, and the through put for at least some embodiments, a satisfactory performance may be achieved. Furthermore, since gravity no longer pulls material directly down through a pulverizer to an exit, it may be desirable to select a different size reduction technology and/or configure the arms in such a way so that the turbulence areas created internal to a pulverizer not only assist in breaking up material but also preferably assist in linearly directing the transmittal of treated material towards an outlet which could then be directed into a hopper and/or possibly assist in lifting material upwardly for internal storage within a storage body.

Finally, some embodiments may envision the vehicle with a first hopper which could direct input to a pulverizer and/or a first storage body located in front of forward of a pulverizer whereby the material could be stored in the first storage body for at least a period of time and then, possibly when getting ready to discharge material, it may be that the material is conveyed or otherwise directed into the pulverizer with a transfer system for use in pulverizing discharged material. A second storage body may contain treated material after exiting the pulverizer.

Improvements to this design could provide a first hopper and/or first storage body located forward of the cab of the vehicle, such as supported by arms, which could receive inserted material, reduce it in size, and then direct the reduced in size material rearwardly to the second storage body, whether by using the arms to dump to the second storage body and/or using vacuum or conveyor technology

Mobile size reduction devices can take various forms whether they possibly require a vehicle being in park or neutral before the size reduction equipment can operate. Some other may provide a storage volume in front of a size reduction device for storage so the size reduction device need not run every time the vehicle stops for a load of material since it is either for a front loader or a side loading vehicle.

For some embodiments the size reduction device can be utilized to assist in discharging garbage from the truck either from during a normal discharge in the operations and/or as an alternate alternative to filling a storage body.

A transfer system such as a conveyor system can be connected on the vehicle so as to discharge from the size reduction device to a storage body for storage and/or to assist in feeding a size reduction device from the storage location. In addition to conveyor systems, augers or other transfer systems may be used for other embodiments either into or out of the size reduction device.

Many pulverizers may be loaded from above the vehicle such as from top for vertically oriented pulverizers. Still other pulverizers may be loaded in other ways. Additionally, some pulverizers may not only be located vertically like the Burkett pulverizer, but angled at an angle such as up to about 45 degrees or even horizontal at i.e. 90 degrees relative to the vertical mill shown in Burkett for at least some embodiments. Pulverizer shafts may be driven by a PTO or possibly by their own motor. Other size reduction devices may operate similarly or dissimilarly to pulverizers.

In order to compress material before feeding to some size reduction devices, it may be desirable for some embodiments to provide a reducer to reduce the cross-section size of material put into the size reduction device so that it a somewhat smaller inlet may be utilized for at least some embodiments. Still other improvements may be provided with this or other embodiments.

### BRIEF DESCRIPTION OF THE DRAWINGS

The particular features and advantages of the invention as well as other objects will become apparent from the following description taken in connection with the accompanying drawings in which:

FIG. 1 is a side plan view of a presently preferred embodiment of the present invention;

FIG. 2 is a side plan view of an alternative embodiment shown in FIG. 1;

FIG. 3 is a top plan view of the embodiment shown in FIG. 2;

FIG. 4 is a side plan view of an alternative embodiment of a size reduction device similar to those shown in FIGS. 1 and 2;

FIG. 5 is a side plan view of an alternative embodiment similar to those shown in FIGS. 1, 2 and 4;

FIG. 6 is a cross sectional view of a size reduction device shown in FIG. 1;

FIG. 7 is a side plan view of an alternative embodiment of a size reduction similar to those shown in FIGS. 1, 2, 4 and 5;

FIG. 8 is a cross sectional view of a size reduction device similar to those shown in FIGS. 1, 2, 4 and 5 and 7; and

FIG. 9 is a side plan view of a mobile size reduction device similar to the embodiments in FIGS. 1, 2, 4, 5, 7, and 8; and

FIG. 10 is a side plan view of a forward mounted size reduction device of another alternatively preferred embodiment.

### DETAILED DESCRIPTION OF THE PREFERRED EMBODIMENT

FIG. 1 shows a mobile size reduction device 10 in the form of a vehicle having a frame 12 supporting a cab 14 a pulverizer or other size reduction device 16 and a storage body 18. The size reduction device 16 in this embodiment could be a vertically oriented pulverizer that could be similar to the Burkett construction shown in U.S. Pat. No. 3,987,970 (incorporated in its entirety herein by reference) or other size reduction device mill construction. This embodiment has at least two discharge options: first a door 20 could be opened to discharge out the side of the vehicle 10 and/or second, a discharge outlet which could be onto a conveyor 22 or other transfer device (such as with the door shut 20). There are also other ways to potentially direct discharge from one of multiple outlets as would be understood by those of ordinary skill in the art. If the discharge proceeds on to conveyor 22 it then may preferably be lifted to an elevation into the storage body 18 to then potentially discharge into the volume thereof.

As can be observed from FIG. 1, a conveyor 20 preferably proceeds into a cavity 24 of the storage body 18 from any embodiments to where it discharges material 26 therein.

For some embodiments in order to operate the size reduction device 16 it may be required to place the vehicle 10 in park (or neutral) and by providing a signal from the transmission 28 for which the operation of size reduction device 16 may be controlled by a processor 30. If the size reduction device 16 is driven by a PTO connection 32 from the engine 34, it may be necessary for some embodiments to have the vehicle 10 in park in order to have enough energy to be able to create the necessary rotation internal to the size reduction device 16 to appropriately treat materials placed therein. Neutral may be an appropriate position for transmission 28 for some embodiments as well. Other embodiments may not require such features. Still other embodiments may be driven by primary or secondary power sources as are used on vehicles 10, possibly including direct drive or other power sources.

For some embodiments such as the embodiment shown in FIG. 7 of a vehicle 100 there may be an initial storage volume 102 provided in front of size reduction device 104 which may selectively convey such as with a conveyor 106 material into the size reduction device 104 for treatment and storage in storage body 106. Using such a configuration made possible that the size reduction device 106 may need not operate every time that a loading event occurs other embodiments could operate differently. Other ways to provide a first volume could be including storage volume 36 above the size reduction device 16 for other embodiments. Still other ways could address this issue as well. Loading could be with a loading system, i.e. a front end loader, side loader, and/or other loader which lifts and dumps input so that it can be directed into an inlet of the size reduction device either directly or with a transfer system.

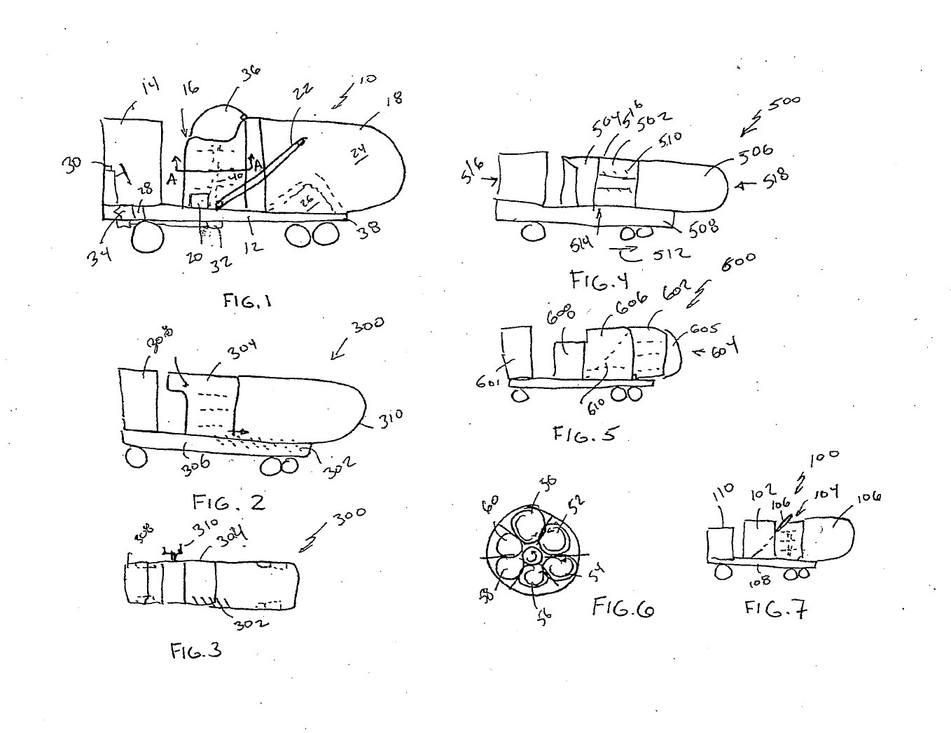

Augers such as auger 302 shown in FIGS. 2 and 3 with reference to vehicle 300 could be used to load or move discharge relative to a size reduction device 304. Other transfer devices could be utilized with other embodiments.

In addition to conveyors such as conveyor 22 and others, augers 302 and others, there may be other ways of assisting in moving material such as into or out of a size reduction devices 16, 104, 210, 304 such as with chute 202 and/or other appropriate mechanism(s).

In the various embodiments, the size reduction devices 16, 304, 104, 210 shown connects to various frames such as frame 38, 306, 108 and 212 of vehicles 10, 100, 200 and 300. In many embodiments it is envisioned that a storage body 18 will be provided to collect material discharged from the size reduction device 16. Storage body 18 can be adjacently disposed relative to size reduction device 10, 100 as shown in FIGS. 1 and 2. Vehicles 10 can use a transfer mechanism such as a chute 22 to direct material from a discharge in size reduction device 16 to the storage body 18 or they can work in various ways such as shown in various figures or as would be understood by those of ordinary skill in the art through the various figures.

Transfer mechanisms such as conveyor 22 can be connection to the frame 12 or 38 as could the auger 302. Other transfer mechanisms could be utilized with various embodiments such as, but not limited to, chutes, vacuums, spreaders, blowers, sprayers, augers, conveyors, compactors, and/or other material moving device(s). Some of the transfer mechanisms may extend into the frame 12 or 38 such as the auger 302 or even below the frame for some embodiments. Size reduction devices such as size reduction devices 16, 304, 104 and 210 can be loaded from above the cabs such as cab 14, cab 308, cab 110, and cab 214 whether it be a front loader such as with arms 216 shown in FIG. 9, a side loader such as with arms 310 or other way of loading the size reduction devices 16, 304, 104, 210 or a storage volume before the size reduction devices 16, 304, 104, 210. Other embodiments may not have a cab 110, such as is provided on a train car, etc.

For the embodiment of FIG. 1 the shaft 40 of size reduction device 16 is shown as being driven from below the frame 12 and even below the size reduction device 16 such as with a PTO connection or otherwise. Torque can be imparted to the shaft 40 in this embodiment from below the frame 38 on which the size reduction device 16 rests. Other embodiments may function differently.

In addition to a chute 22, augers 302 could be utilized for some embodiments as well as to discharge. Other embodiments may have no augers 302 and instead rely on a curve 310 of the storage body 300 or other device to assist in filling the storage body 300 through direct discharge or otherwise.

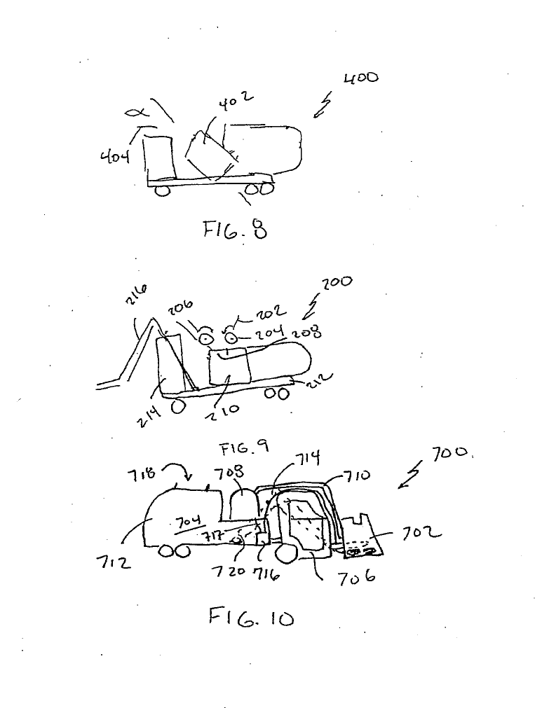

In addition to vertical mill pulverizers as the size reduction device such as shown in FIGS. 1, 2, 3, 5, 7 and 9, it is possible to provide an angled mill, whether or pulverizer or other construction, such as shown in FIG. 8 with a vehicle 400 having a size reduction device 402 having a rotating shaft oriented angle α relative to horizontal 404 with a located at about 45 degrees in this embodiment. α could possibly be in a range of between 0-90, like 0-80 degrees, etc. degrees with other embodiments such as the embodiment of FIG. 4 which shows vehicle 500 a horizontally disposed pulverizer 502 is shown which can be fed from feeder 504 which directs material into size reduction device 502 which can then be directed out into storage body 506 resting on frame 508 (i.e., or is zero degrees). In such an embodiment it is likely to configuration of the arms 510 may be slightly different than in other embodiments so as to assist in directing material horizontally in the direction 512. For a horizontally oriented mill, gravity will not provide the same assistance as in vertical mills to direct material from top to bottom through the mill for processing. Instead, gravity would tend to pull the material to the side wall 514 instead of into the storage body 506 as directed by the feeder 504. Feeder 504 may be a hopper which accepts material and directs it to the size reduction device 502. Hoppers generally are not thought of as storing material or discharged material. Accordingly changing the configuration of the arms 510 to possibly be more blade oriented (like a propeller) could assist in providing not only a crushing configuration such as shown in cross section of FIG. 6 and as occurs in other pulverizers to create the six vertices shown, namely 50, 52, 54, 56, 58 and 60, but also direct the treated material horizontally. Typically pulverizers are facilitated by gravity to direct the material from top to the bottom. Other size reduction technologies may not be as affected by gravity as the pulverizer construction. However, without the gravity assistance in FIG. 4 due to its horizontal nature, then other features such as arm configuration 510 and deflectors along the sides 516 or other features can facilitate movement of material the direction 502 and preferably from front 516 towards rear 518 for many embodiments. Gravity may be sufficient for other angled size reduction devices 402.

FIG. 5 shows another embodiment of the vehicle 600 which has the size reduction device 602 towards the rear 604 of the vehicle 600 and preferably a feeder 606 in front. Possibly, a compactor 608 assists in compacting material into the feeder 606. Possibly a transfer mechanism such as a conveyor 610 may assist in feeding the size reduction device 602 such as immediately before discharging material out the rear 604 of the location of the vehicle 600.

To the applicants knowledge no one has ever made a centrifugal mill or pulverizing mill angled at any degree other than vertically. The application using angles α of at least 10 degrees if not up to 45 degrees or even horizontally to provide the size reduction device 500 such as shown in FIG. 4 for at least some embodiments.

The applicant is also envisioning an embodiment of a vehicle frame supporting a cab 601 behind which a size reduction device 602 is disposed as well as at least one of a feeder 606 and a storage body 605 for storing materials either prior to feeding the size reduction device 602 and/or after being treated by the size reduction device 602. Transfer mechanisms of various kinds shown herein or otherwise can facilitate the movement of material 26 either into the size reduction devices or out of the size reduction devices. Transfer mechanisms of various kinds could be utilized with various embodiments such as, but not limited to, chutes, vacuums, conveyors, spreaders, blowers, sprayers, augers, compactors, and/or other material moving devices.

Accordingly, instead of having just a stationary size reduction device from which material must be provided therein at some specific geographic location, the applicant can now take size reduction remotely. Furthermore, the rate at which the density of input material is increased by a size reduction device, for at least some materials, may be similar to or greater than traditional size reduction methods. Additionally, some embodiments may increase the density of material to a higher density than prior art methods so that more material may be stored in a smaller space to therefore potentially reduce the number of trips and therefore make some embodiments more efficient than prior constructions.

For many embodiments the transfer mechanisms such as conveyor 222 and/or auger 302 be located along the side of the vehicle and still for other embodiments could be centrally disposed.

FIG. 10 shows a vehicle 700 having a forward mounted size reduction device 702, which also can function as a first storage body to retain inserted material prior to reducing in size as well as reduced in size material prior to directing rearwardly to a second storage body illustrated as a refuse compartment 704. In order to transfer material from in front of cab 706 to the refuse compartment 704 behind the cab 706 (and possibly above the cab 706), a transfer device 708 may be utilized such as a vacuum or other pneumatic device, with duct 710. Transfer mechanisms of various kinds could be utilized with various embodiments such as, but not limited to, chutes, vacuums, conveyors, spreaders, blowers, sprayers, augers, compactors, and/or other material moving devices. Still other embodiments could use arms 720 (shown in phantom) to dump a can (or other refuse container) in container inlet 718. Suitable vacuums could include those manufactured by Pneuvay of Australia or others. Duct 710 could be located provide suction to the size reduction device 702 to direct contents to the refuse compartment 704.

The size reduction device 702 could have a can grabber 712 and/or first storage body, somewhat similar in construction to those described in U.S. Pat. Nos. 5,639,201 & 7,210,890, incorporated by reference herein in their entireties. The size reduction device 702 could provide a duct 714 to direct liquid which might be separated from material reduced in size by the size reduction device 702 to ta tank 716, which could be behind the cab 706 as well. Transfer device 708 could have a drain 717 or duct (such as from a pump) to direct fluid to tank 716 (or other tank) as well.

Some embodiments may run on natural gas such as provided from a compressed natural gas (CNG) tailgate 712. Other embodiments may operate on diesel or gas fuels, or even other energy sources. Tailgate 712 may also provide a location for dumping or removing material from the refuse compartment 704.

Organic waste and/or high moisture content waste is believed to be a larger and larger percentage of waste for some municipalities and others. High moisture waste can be more difficult to transfer than other wastes under certain circumstances. Having a separate way to remove moisture and preferably collect that moisture may increase the efficiency and/or ease of conveying material with at least some of the moisture removed.

Numerous alterations of the structure herein disclosed will suggest themselves to those skilled in the art. However, it is to be understood that the present disclosure relates to the preferred embodiment of the invention which is for purposes of illustration only and not to be construed as a limitation of the invention. All such modifications which do not depart from the spirit of the invention are intended to be included within the scope of the appended claims.

Having thus set forth the nature of the invention, what is claimed herein is:

1. A vehicle mounted size reduction device system comprising:
a vehicle having a size reduction device connected thereto, said size reduction device receiving input at an inlet, reducing the size thereof through one of pulverizing and grinding to particulate, and then directing the particulate into one of an outlet and a storage body connected to the vehicle;
a loading system connected to the vehicle for feeding input into the size reduction device, said loading system lifting and dumping input onto the vehicle to be directed into the inlet of the size reduction device.

2. The vehicle mounted size reduction device system of claim 1 wherein the size reduction device has a rotating shaft which rotates about a shaft axis and the shaft axis is angled at an angle α of between about 0-80 degrees relative to horizontal.

3. The vehicle mounted size reduction device system of claim 2 wherein angle α is at about zero degrees relative to horizontal.

4. The vehicle mounted size reduction device system of claim 1 wherein the size reduction device is a pulverizer.

5. The vehicle mounted size reduction device system of claim 1 wherein the storage body is located behind a cab of the vehicle and wherein the size reduction device is located in front of the cab of the vehicle in a first configuration connected to forks.

6. The vehicle mounted size reduction device system of claim 1 wherein the particulate from the size reduction device is selectably directed through (a) the outlet external to the vehicle and (b) into the storage body.

7. The vehicle mounted size reduction device system of claim 1 wherein the storage body has a curved rear door assisting in filling the storage body.

8. The vehicle mounted size reduction device system of claim 1 further comprising a diverter in the storage body assisting in filling the storage storage body with particulate from the size reduction device.

9. The vehicle mounted size reduction device system of claim 1 wherein the loading system further comprises one of front end loader forks and a side loading arm.

10. The vehicle mounted size reduction device system of claim 9 wherein the input is loaded into the size reduction device from above a cab of the vehicle.

11. The vehicle mounted size reduction device system of claim 1 wherein the size reduction device is driven by one of a primary and a secondary power source of the vehicle.

12. The vehicle mounted size reduction device system of claim 11 wherein the size reduction device is operated by one of a power take off and direct drive.

13. The vehicle mounted size reduction device system of claim 1 having a first storage body receiving input from the loading system.

14. The vehicle mounted size reduction device system of claim 13 further comprising a transfer system from the first storage body to the inlet of the size reduction device.

15. The vehicle mounted size reduction device system of claim 14 wherein the transfer system is one of a chute, a conveyor, an auger and a vacuum.

16. The vehicle mounted size reduction device system of claim 1 wherein the storage body receives particulate from a transfer system.

17. The vehicle mounted size reduction device system of claim 16 wherein the transfer system is one of a chute, a conveyor, an auger and a vacuum.

18. The vehicle mounted size reduction system device of claim 16 wherein the loading system picks up and dumps refuse containers containing the input.

19. A vehicle mounted size reduction device system comprising:
a vehicle having a size reduction device connected thereto, said size reduction device receiving input at an inlet, reducing the size thereof through one of pulverizing and grinding to particulate, and then directing the particulate into a storage body connected to the vehicle;
a transfer system connected to the vehicle for feeding particulate generated from the size reduction device, said transfer system lifting and dumping the particulate into the storage body.

20. The vehicle mounted size reduction device system of claim 19 wherein the particulate from the size reduction device is selectably directed through (a) an outlet external to the vehicle and (b) into the storage body, and
further comprising a loading system connected to the vehicle for feeding input into the size reduction device, said loading system lifting and dumping input onto the vehicle to be directed into the inlet of the size reduction device.
